(19) United States
(12) Patent Application Publication
(10) Pub. No.: US 2006/0150820 A1
(43) Pub. Date: Jul. 13, 2006

(54) Granulator device for the treatment of powdered products

(76) Inventors: Salvatore Fabrizio Consoli, Bologna (IT); Andrea Nora, Castelnuovo Rangone (Modena) (IT); Robert Trebbi, Castenaso (Bologna) (IT)

Correspondence Address: ARENT FOX PLLC, 1050 CONNECTICUT AVENUE, N.W., SUITE 400, WASHINGTON, DC, 20036, US

(21) Appl. No.: 10/567,159

(22) PCT Filed: Aug. 2, 2004
(86) PCT No.: PCT/IB04/02550

§ 371 Date: Feb. 3, 2006

(30) Foreign Application Priority Data
Aug. 7, 2003 (IT) BO2003A000485

(51) Int. Cl. B01D 47/00

(52) U.S. Cl. 96/243

(57) ABSTRACT

A granulator device (1) for the treatment of powdered products comprises at least one closed container (2) forming a chamber (3) for treatment of the products; filter elements (4, 5) projecting into the treatment chamber (3), the filter elements (4, 5) comprising at least one multi-layer filtering wall (5) through which at least one fluid current can pass; and powder removing parts (6; 7, 8, 9, 10, 11) designed to diffuse at least one service fluid directed towards the filtering wall (5); the powder removing parts (6; 7, 8, 9, 10, 11) comprising at least a first arm (10) mobile relative to the filtering wall (5) and fitted with a set of first diffuser nozzles (7), the set of first nozzles (7) being positioned on the first arm (10) in such a way that it gradually covers the length of the surface of the filtering wall (5), as the arm (10) moves, diffusing the service fluid so as to free the filtering wall (5) of the powders trapped in it.

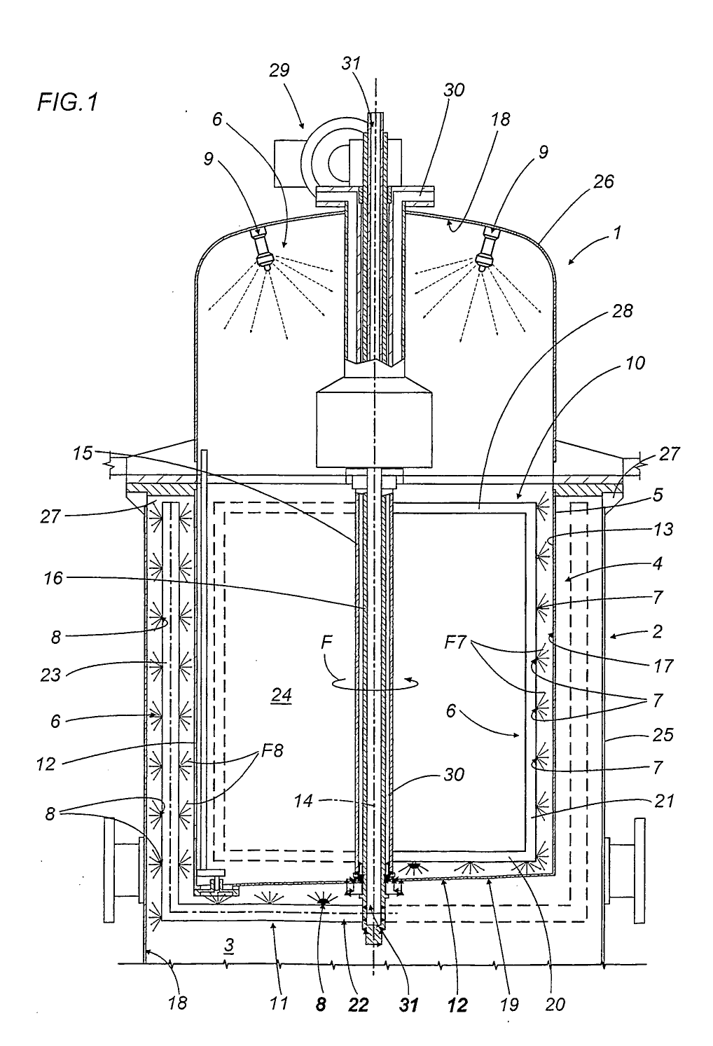

### TECHNICAL FIELD

The present invention relates to a granulator device for the treatment of powdered materials.

In particular, the invention relates to the treatment of powdered materials such as powdered chemical and pharmaceutical products, to which specific reference is made in the following description, without thereby limiting the scope of the invention, using an operating fluid current, that is to say, gaseous fluids or nebulised liquids which, according to the various cases, is used to disagglomerate, wash, support, transport and coat the powdered products during their specific treatment.

### BACKGROUND ART

In powdered materials technology devices are known which are commonly called fluid bed granulator devices, generally used for the treatment of the materials and basically comprising containers with sealed walls, delimiting a chamber for treatment of the materials, permanent filters, with solid walls, projecting into the treatment chamber, means for conveying an operating fluid current through the chamber, and means designed to perform operations which remove powder from and wash the permanent filters.

The operations for removing powder from and washing the filters, designed to restore the original functionality of filters clogged or whose efficiency was reduced by use, or to prepare the device to treat a different product to that treated in a previous processing cycle, have quite a critical role in many powder technologies used, for example, for some chemical or pharmaceutical products.

Such operations must be performed in a suitable way to prevent the operating fluids entering the device from contaminating the product and/or the operating fluids fed out of the device from contaminating the environment, and/or maintenance operations on the filters and on the other operating parts of the device from constituting a health risk for the personnel who carry them out, and for the surrounding environment.

A granulator device of the type described above is known, for example, in patent EP 781.585 B1, in which the permanent filters have rigid filtering walls formed by two or more overlapping layers of metal mesh which are made integral with one another by a sintering process.

Therefore, powder is removed from the filters and they are washed respectively by blowing counterflowing pressurised air through the filtering wall, the air emitted from stationary nozzles covering the entire extent of the filtering surface of each of the filters, and by washing down the outer surface of the filters by directing a flow of water diffused from special nozzles, also stably supported by the outer walls of the container which circumscribes the product treatment chamber.

A device structured in this way allows satisfactory filter cleaning for most applications, in particular during the treatment of powdered products for pharmaceutical use, but is very complex from a construction viewpoint, very expensive and it is particularly difficult to check its effectiveness.

For these reasons, granulator devices are currently known and used which are made as separable modules with independent drive units, so that maintenance personnel find it easier to manually remove powder from and wash the filters when they are permanent, or granulator devices with filter means consisting of bags of special filtering fabrics applied on metal wire frame supporting structures, such as that described and illustrated in U.S. Pat. No. 5,723,160, so that maintenance operations simply consist of substituting the filter bags.

However, such fabric filters are particularly expensive and their simple substitution involves opening the above-mentioned treatment chamber, and so inevitably contamination of the chamber by external agents.

### DISCLOSURE OF THE INVENTION

The aim of the present invention is, therefore, to overcome the disadvantages of the prior art described above.

In particular, one aim of the present invention is to provide a granulator device with simple, inexpensive construction and in which the operations for removing powder from and washing the filtering means can be performed with great efficiency and speed.

Accordingly, the present invention provides a granulator device for the treatment of powdered products, comprising at least one closed container forming a chamber for treatment of the products; filter means projecting into the treatment chamber, the filter means comprising at least one multi-layer filtering wall through which at least one fluid current can pass; and powder removing parts designed to diffuse at least one service fluid directed towards the filtering wall; the device being characterised in that the powder removing parts comprise at least a first arm mobile relative to the filtering wall and fitted with first diffuser nozzles, the first nozzles being positioned on the first arm in such a way that it gradually covers the length of the surface of the filtering wall, as the arm moves, diffusing the service fluid so as to free the filtering wall of the powders trapped in it.

### BRIEF DESCRIPTION OF THE DRAWINGS

The technical features of the invention, according to the above-mentioned aims, are clear in the claims herein and the advantages are more evident in the detailed description which follows, with reference to the accompanying drawing, which represents a preferred, non-limiting embodiment of the invention, schematically illustrating, with some parts cut away and other parts in cross-section, a front view of a granulator device in accordance with the invention.

### DETAILED DESCRIPTION OF THE PREFERRED EMBODIMENTS OF THE INVENTION

With reference to the accompanying drawing, the numeral 1 denotes as a whole a granulator device for the treatment of powdered pharmaceutical products which uses, for the specific treatment cycle, in the conventional and known way, a fluid current designed for example to transport, support, coat, humidify, etc. the powdered products.

The device 1 basically comprises a conventional container 2 and a filter 4 with relative powder removing means, labelled 6 as a whole.

The container 2 has a vertical cylindrical body 25 and is closed at the top by a dome 26, the lower part having walls 18 which encompass, completely delimiting, a chamber 3 for treatment of the products.

The single filter 4 preferably, but without limiting the scope of the invention, has the shape of a completely hollow solid, axially symmetrical which, as illustrated, is formed by a cylindrical cover, with a flat, oblique base 19, which is inverted, that is to say, with its hollow 24 open towards the top of the container 2.

The filter 4 also includes a filtering wall 5 extending both to the side, cylindrical edge of the filter 4 and to the oblique flat base 19.

The filtering wall 5 is rigid and consists of multiple layers, obtained by overlapping a series of layers of metal mesh, having links with variable width, which are held integral with one another by a sintering process. Such a filtering wall 5 is preferably obtained starting with corresponding semi-finished products made and marketed by the Swiss company BOPP & CO. AG, which has operated in the technical sector for the granulation of powdered pharmaceutical material since 1987, with the brand names “POREMET” or “ABSOLTA”.

The filter 4, suitably supported by flanges 27 on the container 2 cylindrical body 25, projects into the treatment chamber 3, so that the fluid current (e.g.: air) passes through it as well as through the treatment chamber 3 when the powder is treated, in a way that is well known and not illustrated.

The means 6 for removing powder from the filter 4 normally comprise three types of nozzles 7, 8, 9 evenly distributed and two arms 10 and 11 designed to support the first two types of nozzles 7 and 8 in the operating condition, whilst the third nozzles 9 are attached to one of the walls 18 of the container 2.

The first type of nozzle 7 is attached to a first arm 10 and allows the diffusion towards the filter 4 of a first gaseous fluid consisting, for example, of pressurised air. The second and the third types of nozzle 9 both spray a current of water designed to wash down the parts of the device 1 from which powder is to be removed. The second 8 and third 9 types of nozzle differ from one another mainly because the second nozzles 8 are supported by a second, mobile arm 11, whilst the third nozzles 9 are stationary and supported by the container 2 dome 26.

The accompanying drawing illustrates how the two arms 10 and 11 have a shape which matches the meridian profiles respectively inside and outside the cover which forms the filter 4.

More particularly, the first arm 10 comprises three segments 20, 21, 28, straight and integral with one another, angled to project cantilever style from a tubular drive shaft 15, coaxial with the cover.

The second arm 11 consists of just two consecutive segments 22 and 23, projecting from a drive shaft 16 which also passes through the cover—filter 4 and in turn housed in the drive shaft 15 of the first arm 10.

Two segments 20 and 21 of the three segments 20, 21, 28 of the first arm 10 are fitted with the first nozzles 7 which project in a single direction towards the internal face 13 of the filter 4 filtering wall 5.

Both of the segments 22 and 23 of the second arm 11 are fitted with second nozzles 8. However, some of them are directed in a single direction towards the external face 12 of the base 19 of the filter cover 4. The remaining nozzles 8, located on the adjacent segment 23 of the arm are directed in two opposite directions: one opposite the external face 12 of the filter 4 relative to the cylindrical side surface; the other opposite the internal wall 18 of the container 2 body 25, also cylindrical.

The two drive shafts 15 and 16 are mechanically connected to drive means 29 outside the container 2 dome 26. The shafts 15 and 16, being hollow inside, allow the most suitable service fluid to flow through them to the nozzles 7 and 8 of the two arms 10 and 11. The fluid comes from outside the container 2 and is supplied by conventional feed means, known and not illustrated.

As shown in the accompanying drawing, a first pipe 30 running through the first shaft 15 carries compressed air to the nozzles 7 of the first arm 10. A second pipe 31, running through the second shaft 16 carries water for washing to the second nozzles 8. Similar pipes, not visible in the drawing, carry water for washing to the third nozzles 9 fitted to the container 2 dome 26.

Operation of the powder removing means is easily imagined by observing that thanks to the drive units connected to them, the two arms 10 and 11 can rotate (see arrow F for anti-clockwise rotation) about a fixed axis of rotation which coincides with the filter 4 axis of symmetry 14 and can simultaneously carry the service fluid to be diffused against the filter 4 (see flow arrows F7 and F8) to the respective nozzles 7 and 8.

Since the first and second nozzles 7, 8 are fitted to the respective arms 10, 11 in such a way that they are opposite a filtering wall 5 surface area that is relatively limited and substantially confined about a generatrix 17 of the shape of the filtering wall 5 (a wall which may be considered generated by rotation of the generatrix 17 about the axis 14 of the solid—filter 4), the rotation of the arms 10, 11 combined with ejection of the service fluids from the respective nozzles 7, 8 allows the entire length of the surface of the filtering wall 5 to be gradually covered, concentrating the entire service fluid flow on limited areas in turn.

Therefore, this maximises the efficiency of powder removal from the filter—using gaseous fluids or by washing down, according to the types of nozzles considered—allowing rapid, simple powder removal from the filter 4 taken to the highest levels and without the operator having to intervene and open the treatment chamber 3.

Obviously, the presence of nozzles 8 directed at the container 2 internal wall 18 and nozzles 9 fitted to the container 2 dome 26 allows powder removal operations to also be extended to the remaining parts of the device, that is to say, to the entire container 2 treatment chamber 3.

The invention described can be subject to modifications and variations without thereby departing from the scope of the inventive concept. Moreover, all the construction details of the invention may be substituted by technically equivalent elements.

1. A granulator device (1) for the treatment of powdered products comprising at least one closed container (2) forming a chamber (3) for treatment of the products; filter means (4, 5) projecting into the treatment chamber (3), the filter means (4, 5) comprising at least one multi-layer filtering wall (5) through which at least one fluid current can pass; and powder removing means (6; 7, 8, 9, 10, 11) designed to diffuse at least one service fluid directed towards the filtering wall (5); the device (1) being characterised in that the powder removing means (6; 7, 8, 9, 10, 11) comprise at least a first arm (10) mobile relative to the filtering wall (5) and fitted with first diffuser nozzles (7), the first nozzles (7) being positioned on the first arm (10) in such a way as to gradually cover the length of the surface of the filtering wall (5), as the arm (10) moves, diffusing the service fluid so as to free the filtering wall (5) of the powders trapped in it.

2. The device according to claim 1, characterised in that the filtering wall (5) belongs to a filter (4) which has the shape of a completely hollow solid;
the first nozzles (7) projecting towards the filtering wall (5) from the inside of the solid formed by the filter (4).

3. The device according to claim 1 or 2, characterised in that the arm (10) is rotatably mounted about a fixed axis of rotation (14) of the filtering wall (5) to rotate about the axis (14).

4. The device according to claim 2, characterised in that the powder removing means (6; 7, 8, 9, 10, 11) also comprise a second arm (11) fitted with second nozzles (8) for diffusing the service fluid; the second arm (11) also being mobile relative to the filtering wall (5).

5. The device according to claim 4, characterised in that the first arm (10) and the second arm (11) are respectively facing opposite faces (12, 13) of the filtering wall (5).

6. The device according to claim 4, characterised in that the first and second arms (10, 11) are both rotatably mounted about a shared axis of rotation (14) to rotate about the axis (14).

7. The device according to any of the foregoing claims from 4 to 6, characterised in that the first arm (10) is rotatably mounted to rotate inside the filtering wall (5) and the second arm (11) is rotatably mounted to rotate outside the filtering wall (5).

8. The device according to claim 4, characterised in that the filtering wall (5) belongs to a filter (4) which has the shape of a symmetrical solid; the first and second nozzles (7, 8) being fitted on the respective arms (10, 11) in such a way that they are opposite a limited surface area around a generatrix (17) of the shape of the filtering wall (5) following rotation of the line (17) about the axis (14) of the solid.

9. The device according to claim 4, characterised in that the second arm (11) comprises the second nozzles (8) opposite at least one wall (18) of the container (2), rotation of the second arm (11) being designed to allow the removal of powders from the surface of the container (2) wall (18).

10. The device according to claim 1, characterised in that the service fluid is a pressurised gaseous fluid.

11. The device according to claim 1, characterised in that the service fluid is a fluid in the wet state.

12. The device according to claim 4, characterised in that the filter (4) has the shape of an inverted cover, the first and second arms (10, 11) having a shape matching the meridian profile of the cover.

13. The device according to claim 12, characterised in that the cover has an oblique flat base (19).

14. The device according to claim 12 or 13, characterised in that the cover has a cylindrical shape.

15. The device according to any of the foregoing claims 4, 5, or 6, characterised in that the powder removing means (6; 7, 8, 9, 10, 11) comprise third diffuser nozzles (9) attached to one of the walls (18) of the container (2) to diffuse a service fluid in the wet state.
